(19) United States
(12) Patent Application Publication
(10) Pub. No.: US 2023/0007736 A1
(43) Pub. Date: Jan. 5, 2023

(54) DISPLAY SIGN HEATING APPARATUS, METHOD OF MAKING AND USING THE SAME

(71) Applicant: Skyline Products, Inc., Colorado Springs, CO (US)

(72) Inventors: James A. Barnhart, Colorado Springs, CO (US); Richard L. Hogan, Colorado Springs, CO (US); Patrick B. Cochran, Colorado Springs, CO (US)

(21) Appl. No.: 17/848,189

(22) Filed: Jun. 23, 2022

Related U.S. Application Data
(60) Provisional application No. 63/217,555, filed on Jul. 1, 2021.

(51) Int. Cl. H05B 3/22; G09F 13/22

(52) U.S. Cl. CPC H05B 3/22; G09F 13/22; G09F 2013/222; H05B 2214/02; H05B 2203/005; H05B 2203/013

(57) ABSTRACT

Aspects of the invention generally relate to a display sign heating apparatus, method of making and using the same and more particularly to a display sign for preventing or mitigating snow and icing from interfering with the display.

### CROSS REFERENCE TO RELATED APPLICATIONS

This application claims the benefit of U.S. Provisional Application No. 63/217,555 on filed Jul. 1, 2021, which is hereby incorporated by reference as if fully set forth herein.

### BACKGROUND OF THE INVENTION

### Field of the Invention

The present invention generally relates to a system and display sign heating apparatus, method of making and using the same, and more particularly to a system and display sign for preventing or mitigating snow and icing from interfering with the display.

### SUMMARY OF THE INVENTION

Accordingly, the invention is directed to a media sanitizer or duplicator that substantially obviates one or more of the problems due to limitations and disadvantages of the related art.

An advantage of the invention is to provide a system that allows for rapid removal of snow, ice, or other obstruction to view an active region of the sign.

Another advantage of the invention is to provide for remote operation of the heat source.

Additional features and advantages of the invention will be set forth in the description which follows, and in part, will be apparent from the description or may be learned by practice of the invention. The objectives and other advantages of the invention will be realized and attained by the structure, particularly pointed out in the written description and claims hereof, as well as the appended drawings.

To achieve these and other advantages and in accordance with the purpose of the present invention, as embodied and broadly described, a display sign apparatus for preventing or minimizing snow and icing from blocking a display portion of the sign, the apparatus including a housing, one or more circuit boards including a plurality of light emitting diodes (LEDs), glazing adjacent the one or more circuit boards and a mask attached to the housing and adjacent to the glazing, the mask having a plurality of apertures aligned with plurality of light emitting diodes (LEDs). The display sign further includes a surface portion attached to the housing including a letter, a number, shape, graphic and/or symbol on a front surface portion. The display sign also includes a heat source attached to the glazing and surrounding a plurality of the plurality of apertures and a thermostat attached to the glazing configured to control the heat source based on a predetermined temperature range.

In another aspect of the present invention, a display sign apparatus for preventing or minimizing snow and icing from blocking a display portion of the sign includes a housing, one or more circuit boards comprising a plurality of light emitting diodes (LEDs), a glazing adjacent the one or more circuit boards and a mask attached to the housing and adjacent to the glazing, the mask having a plurality of apertures aligned with plurality of light emitting diodes (LEDs). The display sign also includes a surface portion attached to the housing including a letter, a number, shape, graphic and/or symbol on a front surface portion. The display sign further includes a heat source attached to the glazing and surrounding a plurality of the plurality of apertures and a controller configured to control the heat source based on predetermined condition.

Yet another aspect of the invention is directed towards a method of using a display sign apparatus for preventing or minimizing snow and icing from blocking a display portion of the sign. The method includes providing a display sign according to any embodiment herein having a heat source. Operating the heat source with the controller in response to a predetermined condition as described herein.

This Summary section is neither intended to be, nor should be, construed as being representative of the full extent and scope of the present disclosure. Additional benefits, features and embodiments of the present disclosure are set forth in the attached figures and in the description herein below, and as described by the claims. Accordingly, it should be understood that this Summary section may not contain all of the aspects and embodiments claimed herein.

Additionally, the disclosure herein is not meant to be limiting or restrictive in any manner. Moreover, the present disclosure is intended to provide an understanding to those of ordinary skill in the art of one or more representative embodiments supporting the claims. Thus, it is important that the claims be regarded as having a scope including constructions of various features of the present disclosure insofar as they do not depart from the scope of the methods and apparatuses consistent with the present disclosure (including the originally filed claims). Moreover, the present disclosure is intended to encompass and include obvious improvements and modifications of the present disclosure.

### BRIEF DESCRIPTION OF THE DRAWINGS

The accompanying drawings, which are included to provide a further understanding of the invention and are incorporated in and constitute a part of this specification, illustrate embodiments of the invention and, together with the description, serve to explain the principles of the invention.

In the drawings:

FIG. 1 illustrates an exemplary block diagram of a communication system for control of one or more network devices according to an embodiment.

FIG. 2 illustrates an exemplary perspective side view of a sign with a heating unit according to an embodiment of the invention.

FIG. 3 illustrates an exemplary exploded view of the sign of FIG. 2.

FIG. 4 illustrates a magnified view of an aperture of the sign shown in FIG. 2.

FIG. 5 illustrates an exemplary rear view of the sign of FIG. 2.

FIG. 6 illustrates an exemplary rear view of the sign of FIG. 2.

FIG. 7 illustrates an exemplary perspective view of a heating unit according to an embodiment.

FIG. 8 illustrates an exemplary magnified view of the heating unit of FIG. 7.

FIG. 9 illustrates an exemplary rear view of the heating unit of FIG. 7.

FIG. 10 illustrates an exemplary front view of the heating unit of FIG. 7.

FIG. 11 illustrates an exemplary view of an interior of a sign according to an embodiment of the invention.

FIG. 12 illustrates an exemplary magnified view of the sign FIG. 11.

FIG. 13 illustrates an exemplary LED panel of the sign in FIG. 11.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

### DETAILED DESCRIPTION OF THE ILLUSTRATED EMBODIMENTS

The following detailed description describes a system and display sign apparatus and is presented to enable any person skilled in the art to make and use the disclosed subject matter in the context of one or more particular implementations. Various modifications, alterations, and permutations of the disclosed implementations can be made and will be readily apparent to those skilled in the art, and the general principles defined may be applied to other implementations and applications without departing from the scope of the disclosure. The present disclosure is not intended to be limited to the described or illustrated implementations but to be accorded the widest scope consistent with the described principles and features.

Appearances of the phrases an “embodiment,” an “example,” or similar language in this specification may, but do not necessarily, refer to the same embodiment, to different embodiments, or to one or more of the figures. The features, functions and the like described herein are considered to be able to be combined in whole or in part one with another as the claims and/or art may direct, either directly or indirectly, implicitly, or explicitly.

As used herein, “comprising,” “including,” “containing,” “is,” “are,” “characterized by,” and grammatical equivalents thereof are inclusive or open-ended terms that do not exclude additional unrecited elements or method steps unless explicitly stated

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” or “about” can, in some embodiments, mean within plus or minus ten percent of the stated value. In other embodiments, “approximately” or “about” can mean within plus or minus five percent of the stated value. In further embodiments, “approximately” or “about” can mean within plus or minus three percent of the stated value. In yet other embodiments, “approximately” or “about” can mean within plus or minus one percent of the stated value.

In order to appreciate the present disclosure more fully and to provide additional related features, each of the following references (1)-(5) are fully incorporated herein by reference in their entireties and for the teachings as follows:

(1) U.S. Pat. No. 7,605,772 issued to Syrstad, which discloses an electronic display panel having a combination of aligned and connected forwardly located panels to which a plurality of rearwardly located LED modules easily and readily secure using three-point attachment to form an electronic display panel suitable for accommodation by and for securing to the structure and framework of a sign system. Configured spacer brackets offer mutual spaced support between the front and rear panels and are constructed using arcuate geometry for dimension minimalizing to prevent interference with the viewing of the LED pixels. Notches are located along the bottom edge of the electronic display panel for simple engagement, such as with an arcuate surface of a pivot bar incorporated in a lower structure of a sign system.

(2) U.S. Pat. No. 7,716,861 issued to Stadjuhar, which discloses an outdoor display sign has a display enclosure. The display enclosure has a number of shades that reduce the solar loading on the display enclosure. The outdoor display sign has shades covering the top, back, sides and parts of the front of the sign. The shades are offset from the display enclosure to allow natural airflow between the shade and the display enclosure.

(3) U.S. Pat. No. 8,446,293 issued to Stadjuhar, which discloses a traffic sign system that has a number of information centers. A communication network provides a communication path between the information centers. The communication network is National Transportation Communications for Intelligent Transportation Systems Protocol (NTCIP) compliant. A sign controller is in communication with the information centers through the communication network. A first sign has a first address with a local control link to the sign controller. The local control link is not National Transportation Communications for Intelligent Transportation Systems Protocol compliant. A second sign has a second address with a second local control link to the sign controller. The second local control link is not National Transportation Communications for Intelligent Transportation Systems Protocol compliant.

(4) U.S. Pat. No. 9,343,000 issued to Stadjuhar, which discloses a fine pitch full color variable message sign has a housing with a front face. A number of printed circuit boards are arranged along the front face of the housing. A number of LEDs are attached to each of the printed circuit boards. The LEDs are grouped into a number of pixels, each pixel has three LEDs arranged in a line. A mask covers the printed circuit boards. The mask has a number of elliptical apertures. A glazing may cover the printed circuit boards and is between the printed circuit boards and the mask. Each pixel has three LEDs; red, blue, and green. The LEDs that form a pixel are arranged in a line. The elliptical apertures are aligned with each pixel.

(5) U.S. Pat. No. 10,078,975, issued to Stadjuhar, which discloses a highway variable message sign with apertures are generally described herein. Various embodiments of a highway message sign comprise a housing and one or more circuit boards. In many embodiments, each of the one or more circuit boards have a plurality of pixels, and each pixel of the plurality of pixels can include one or more lighting elements. The highway message sign can further comprise a glazing adjacent to the lighting elements and a mask attached to the housing and adjacent to the glazing. The mask can have a plurality of apertures aligned with the plurality of pixels at an offset, wherein each pixel of the plurality of pixels is aligned at a different one of the plurality of apertures such that the one or more lighting elements of any pixel of the plurality of pixels are aligned to the same aperture. Other embodiments may be described and claimed.

In one embodiment is directed towards a display sign or sign with a heating unit that is configured to prevent or minimize snow and other moisture freezing on a display sign. Thereby allowing the sign to be visible or more visible and prevent snow or other moisture from visually obscuring the sign. In The terms display and sign are used interchangeably.

In one embodiment, a display sign apparatus for preventing or minimizing snow and icing from blocking a display portion of the sign includes a housing, one or more circuit boards comprising a plurality of light emitting diodes (LEDs), a mask attached to the housing and adjacent to the one or more circuit boards, the mask having a plurality of apertures aligned with plurality of light emitting diodes (LEDs), a heat source attached to the mask and surrounding a plurality of the plurality of apertures, and a thermostat attached to the mask configured to control the heat source based on a predetermined temperature range.

In one embodiment, the display sign apparatus for preventing or minimizing snow and icing from blocking a display portion of the sign includes a housing, one or more circuit boards comprising a plurality of light emitting diodes (LEDs), a glazing adjacent the one or more circuit boards, a mask attached to the housing and adjacent to the glazing, the mask having a plurality of apertures aligned with plurality of light emitting diodes (LEDs), a surface portion attached to the housing including a letter, a number, shape, graphic and/or symbol on a front surface portion, a heat source attached to the mask and surrounding a plurality of the plurality of apertures, and a controller configured to control the heat source based on predetermined condition.

In one embodiment of a display or sign including a housing and one or more circuit boards. Each of the one or more circuit boards have a plurality of pixels, and each pixel of the plurality of pixels can include one or more lighting elements, e.g., LEDs. The display or sign can further comprise a glazing adjacent to the lighting elements and a mask attached to the housing and adjacent to the glazing. The mask can have a plurality of apertures aligned with the plurality of pixels. A heat source attached to the mask or adjacent to the mask. The heat source surrounding a plurality of the plurality of apertures or partially surrounding a plurality of apertures. A thermostat is in electrical communication with the heat source and network. The thermostat is configured to control the heat source based on a predetermined temperature range, automatically, directly or indirectly controlled over the network. Optionally and/or alternatively, each pixel of the plurality of pixels can be aligned at a different one of the plurality of apertures such that the one or more lighting elements of any pixel of the plurality of pixels are aligned to the same aperture. The sign can further include one or more pins having a first end attached to the mask and a structural return separate from the one or more pins and having a first end attached to the mask. In many embodiments, each of the one or more pins extend from the mask and through the glazing and the one or more pins have a second pin end attached to at least one of the one or more circuit boards.

In one embodiment, the sign is a highway variable message sign and includes a housing, and a plurality of printed circuit boards. Each of the plurality of printed circuit boards can have a plurality of pixels, and each pixel includes a plurality of lighting elements, wherein the plurality of lighting elements are contained in a single LED. The sign also includes a glazing adjacent to the plurality of lighting elements and a mask attached to the housing, adjacent to the glazing, and coupled to the plurality of printed circuit boards. In many embodiments, the mask has a plurality of apertures aligned with the plurality of pixels at an offset or not at an offset, wherein each pixel is aligned at a different one of the plurality of apertures. A heat source attached to the mask and surrounding a plurality of the plurality of apertures and a thermostat attached to the mask configured to control the heat source based on a predetermined temperature range.

In some embodiments, the at least three lighting elements can be contained in a single package, such as a tricolor LED or a RGB LED. In some embodiments, each of the groupings of lighting elements contains at least two lighting elements arranged vertically. In some embodiments, each of the groupings of lighting elements contains at least three lighting elements arranged in a vertical line. Each of the at least two or three lighting elements can be the same or different colors.

Optionally and/or alternatively, in some embodiments, each of the plurality of pixels in any highway variable message sign can comprise two columns of lighting elements. For example, a pixel can include six LEDs such that there are two columns of three LEDs, and each of the three LEDs can be the same or different colors. Of course, any number of LEDs may be utilized to achieve any color as known in the art.

The heating unit described herein can be utilized with any type of sign or display, e.g., a traffic sign, sports sign, fuel price sign, or other type of entertainment sign. In one embodiment, the sign or display is described is an outdoor display sign as described in U.S. Pat. No. 7,716,861, which is hereby incorporated by reference. In another embodiment, the sign or display is a fine pitch full color variable message sign as described in U.S. Pat. No. 9,343,000, which is hereby incorporated by reference. In yet another embodiment, the sign or display is a highway variable message sign with apertures as described in U.S. Pat. No. 10,078,975, which is hereby incorporated by reference.

One embodiment is directed towards a display sign apparatus for preventing or minimizing snow and icing from blocking a display portion of the sign includes a housing. The display sign includes one or more light sources and a mask attached to the housing and adjacent to the light source. The mask has a plurality of apertures aligned with the one or more light sources. The display sign further includes a heat source attached to the glazing and surrounding a plurality of the plurality of apertures and a controller configured to control the heat source based on a predetermined condition.

The controller can be any type of controller. For example, the controller can be programmable with predetermined conditions or controlled at the source of the source or remotely. The predetermined conditions can be one or more of the following conditions time of day, time of year, schedule of snowplows, time of heater operation, weather conditions, combinations of the same, and the like. In one embodiment, the controller is a programable timer. In some embodiments, a control system such as the control system in U.S. Pat. No. 8,446,293, which is incorporated by reference herein, can be used.

In one embodiment, one or more devices, e.g., display signs that can be controlled remotely via a wireless network with a control system.

In one embodiment, the controller is a thermostat and connected or attached to any portion of component of the sign, e.g., outer surface of the sign, inner surface of the sign, any interior component, e.g., mask.

Optionally and/or alternatively, the mask can be removed in one embodiment and the heat source can be applied to the interior surface of the sign directly, e.g., directly adjacent on the front surface, rear surface or integral with the sign, e.g., sandwiched inside the sign.

One embodiment is directed towards a display sign apparatus for preventing or minimizing snow and icing from blocking a display portion of the sign includes a housing. The display sign includes one or more circuit boards including a plurality of light-emitting diodes (LEDs), a glazing element or feature adjacent to the one or more circuit boards and a mask attached to the housing and adjacent to the glazing, the mask having a plurality of apertures aligned with the plurality of light-emitting diodes (LEDs). The display sign also includes a surface portion attached to the housing, including a letter, a number, shape, graphic and/or symbol on a front surface portion. The display sign further includes a heat source attached to the glazing and surrounding a plurality of the plurality of apertures and a controller configured to control the heat source based on a predetermined condition.

Optionally and/or alternatively, the heat source can be arranged in any pattern or patterns, e.g., around individual mask apertures, around a row of mask apertures, around a column of mask apertures and/or other pattens. In one embodiment, the heat source can be arranged directly on the outer surface and/or inner surface of the sign.

The one or more or a plurality of light-emitting diodes (LEDs) can be grouped into clusters, known as pixels. A pixel is generally thought of as the smallest single component of an image or display. One or more of the light-emitting diodes (LEDs) can be any color. In one embodiment, any color is achieved with three light-emitting diodes (LEDs) a red light-emitting diode (LED), a blue light-emitting diode (LED), and a green light-emitting diode (LED) to create any color as known in the art.

Optionally and/or alternatively, light sources other than light-emitting diodes (LEDs) can be utilized, e.g., one or more of the following light sources incandescent, fluorescent, laser diode, organic light emitting diode (OLED), quantum dot light emitting diode (QLED), liquid crystal display (LCD) source, plasma display source, fiber optic, other types of light emitting diodes combinations of the same or the like.

Optionally and/or alternatively, other types of displays may be utilized, e.g., Dynamic Message Signs (DMS), Changeable Message Sign (CMS), Blank Out Signs (BOS), Variable Toll Message Signs (VTMS), Lane Usage Signs (LUS), Land Control Signs (LCS), Variable Speed Limit Signs (VSL), DMS Inserts, and Embedded DMS, as known in the art.

In one embodiment, the heat source has one or more controllable thermostats, e.g., a BriskHeat® thermostat model no. TD101N-060 or TD101X-XXX. The thermostat is used to turn the heat source on and off. The thermostat is programable or dynamically controllable directly at its source or over a communication network, e.g., wired, or wireless communication. In one embodiment, the thermostat is programmed to come on at a temperature in a range from about 40° F. degrees or higher and below.

In a preferred embodiment, the temperature range can be in a range from about −60° F. to about 185° F. or greater or less.

In one embodiment, the heat source may be a heat tape, heating cable, heating wire, etched foil heater, aluminum foil heater, conductive heater, or other heating element configured to heat with the application of external energy.

In one embodiment, the heat source includes an etched foil heater. The etched foil heater comprises a conductive material, e.g., foil, metal, alloy, conductive plastic material, or other material. The etched foil heater can include a protective coating, e.g., a thermoplastic material, a Kapton material, a silicon material, a polyimide material, a rubber material, combinations of the same, and the like.

In one embodiment, the etched foil heater has a watt density of 15 watts/in² or less. The etched foil heater can have a watt density of 14 watts/in², 13 watts/in², 12 watts/in², 10 watts/in², 9 watts/in², 8 watts/in², 7 watts/in², 6 watts/in², 5 watts/in², 4 watts/in², 3 watts/in², 2 watts/in², 1 watts/in^{t} or less. The higher the watt density the faster the removal of snow, ice, or other obstruction.

In one embodiment, the etched foil heat source can be operated in zones, e.g., a first zone having a first region, a second zone having a second region, and additional zones. One zone may be configured to have a higher watt density than another zone.

In one embodiment, the heat source includes a protective coated etched foil material having a thickness in a range from about 0.010 inches or greater. Optionally and/or alternatively, the heat source can be any heat source, e.g., temperature controlled material heated with an electrical current, temperature controlled air, and/or temperature controlled fluid.

Optionally and/or alternatively, a controller may be utilized with or without the thermostat. The controller can be programmable with predetermined conditions or controlled at the source of the source or remotely. The predetermined conditions can be one or more of the following conditions: time of day, time of year, schedule of snowplows, time of heater operation, weather conditions, combinations of the same, and the like. In one embodiment, the controller is a programable timer. In some embodiments, a control system or features of the control system are used as described in U.S. Pat. No. 8,446,293, which is incorporated by reference herein.

Optionally and/or alternatively, one or more sensors may be used with or without the thermostat to control the operation of the heat source. The sensors can include one or more of: ice sensors configured to determine if ice is present, snow sensor configured to determine if it is snowing, a moisture sensor configured to determine if a predetermined amount of moisture is on the display, a barometric sensor, an optical sensor configured to determine is snow, ice or moisture is obstructing the display, a temperature sensor, and other sensors indicative of snow or ice and combinations of the same.

In one embodiment, the heat source is configured as a material that heats with current or electricity going through the material. The thermal material is configured to be attached or adhered directly to a portion of the bracket of the display sign or mask. Alternatively, the heat source can be integral with any component of the sign, e.g., arranged or sandwiched between such integral component, e.g., mask, glazing, face of the sign combinations of the same and the like. The bracket or mask is configured to hold or mount a display panel. The bracket has a plurality of holes, slits, or apertures complete through its thickness where the holes are configured to permit light emitted from a light source of the display panel to pass through the bracket.

In one embodiment, the heat source can be a coated or non-coated heat source. The coating will protect the heat source from external conditions, e.g., environmental conditions. In a preferred embodiment, the heat source is an etched foil heat source having a power density in a range from about 2 w/cm² to about 5 w/cm².

The display sign can be any type of sign, e.g., department of transportation sign, store sign, entertainment sign, and the like. The sign can be any dimension, e.g., 1 foot to about 90 foot or greater in height and 1 foot to about 25 foot or greater width. Reference will now be made in detail to an embodiment of the present invention, examples are illustrated in the accompanying drawings.

One embodiment is directed towards a method of using a display sign apparatus for preventing or minimizing snow and icing from blocking a display portion of the sign. The method includes providing a display sign as described in any one of the embodiments herein and operating the heat source with the controller when the predetermined condition is a temperature in range from about 40 degrees or below.

Functional units of the system or sign described in this specification and figures may be labeled as modules, or outputs in order to more particularly emphasize their structural features. A module and/or output may be implemented as hardware, e.g., comprising circuits, gate arrays, off-the-shelf semiconductors such as logic chips, transistors, or other discrete components. They may be fabricated with very-large-scale integration (VLSI) techniques. A module and/or output may also be implemented in programmable hardware such as field programmable gate arrays, programmable array logic, programmable logic devices or the like. Modules may also be implemented in software for execution by various types of processors. In addition, the modules may be implemented as a combination of hardware and software in one embodiment.

An identified module of programmable or executable code may, for instance, include one or more physical or logical blocks of computer instructions that may, for instance, be organized as an object, procedure, or function. Components of a module need not necessarily be physically located together but may include disparate instructions stored in different locations which, when joined logically together, include the module and achieve the stated function for the module. The different locations may be performed on a network, device, server, and combinations of one or more of the same. A module and/or a program of executable code may be a single instruction, or many instructions, and may even be distributed over several different code segments, among different programs, and across several memory devices. Similarly, data or input for the execution of such modules may be identified and illustrated herein as being an encoding of the modules, or being within modules, and may be embodied in any suitable form and organized within any suitable type of data structure.

In one embodiment, the system, components and/or modules discussed herein may include one or more of the following: a server or other computing system including a processor for processing digital data, memory coupled to the processor for storing digital data, an input digitizer coupled to the processor for inputting digital data, an application program stored in one or more machine data memories and accessible by the processor for directing processing of digital data by the processor, a display device coupled to the processor and memory for displaying information derived from digital data processed by the processor, and a plurality of databases or data management systems.

In one embodiment, functional block components, screen shots, user interaction descriptions, optional selections, various processing steps, and the like are implemented with the system. It should be appreciated that such descriptions may be realized by any number of hardware and/or software components configured to perform the functions described. Accordingly, to implement such descriptions, various integrated circuit components, e.g., memory elements, processing elements, logic elements, look-up tables, input-output devices, displays and the like may be used, which may carry out a variety of functions under the control of one or more microprocessors or other control devices.

In one embodiment, software elements may be implemented with any programming, scripting language, and/or software development environment, e.g., Fortran, C, C++, C#, COBOL, Apache Tomcat, Spring Roo, Web Logic, Web Sphere, assembler, PERL, Visual Basic, SQL, SQL Stored Procedures, AJAX, extensible markup language (XML), Flex, Flash, Java, .Net and the like. Moreover, the various functionality in the embodiments may be implemented with any combination of data structures, objects, processes, routines or other programming elements.

In one embodiment, any number of conventional techniques for data transmission, signaling, data processing, network control, and the like as one skilled in the art will understand may be used. Further, detection or prevention of security issues using various techniques known in the art, e.g., encryption, may also be used in embodiments of the invention. Additionally, many of the functional units and/or modules, e.g., shown in the figures, may be described as being “in communication” with other functional units and/or modules. Being “in communication” refers to any manner and/or way in which functional units and/or modules, such as, but not limited to, input/output devices, computers, laptop computers, PDAs, mobile devices, smart phones, modules, and other types of hardware and/or software may be in communication with each other. Some non-limiting examples include communicating, sending and/or receiving data via a network, a wireless network, software, instructions, circuitry, phone lines, Internet lines, fiber optic lines, satellite signals, electric signals, electrical and magnetic fields and/or pulses, and/or the like and combinations of the same.

In one embodiment, communication among the signs, other devices, users, subscribers and/or server in accordance with embodiments of the invention may be accomplished through any suitable communication channels, such as, for example, a telephone network, an extranet, an intranet, the Internet, cloud based communication, point of interaction devices (point of sale device, personal digital assistant, cellular phone, kiosk, and the like), online communications, off-line communications, wireless communications, RF communications, cellular communications, Wi-Fi communications, transponder communications, local area network (LAN) communications, wide area network (WAN) communications, networked or linked devices and/or the like. Moreover, although embodiments of the invention may be implemented with TCP/IP communications protocols, other techniques of communication may also be implemented using IEEE protocols, IPX, Appletalk, IP-6, NetBIOS, OSI or any number of existing or future protocols. Specific information related to the protocols, standards, and application software utilized in connection with the Internet is generally known to those skilled in the art and, as such, need not be detailed herein.

In embodiments of the invention, the system provides and/or receives a communication or notification via the communication system to or from an end user. The communication is typically sent over a network, e.g., a communication network. The network may utilize one or more of a plurality of wireless communication standards, protocols or wireless interfaces (including LTE, BTLE, CDMA, WCDMA, TDMA, UMTS, GSM, GPRS, OFDMA, WiMAX, FLO TV, Mobile DTV, WLAN, and Bluetooth technologies), and may be provided across multiple wireless network service providers. The system may be used with any mobile communication device service (e.g., texting, voice calls, games, videos, Internet access, online books, etc.), SMS, MMS, email, mobile, land phone, tablet, smartphone, television, vibrotactile glove, voice carry over, video phone, pager, relay service, teletypewriter, and/or GPS and combinations of the same.

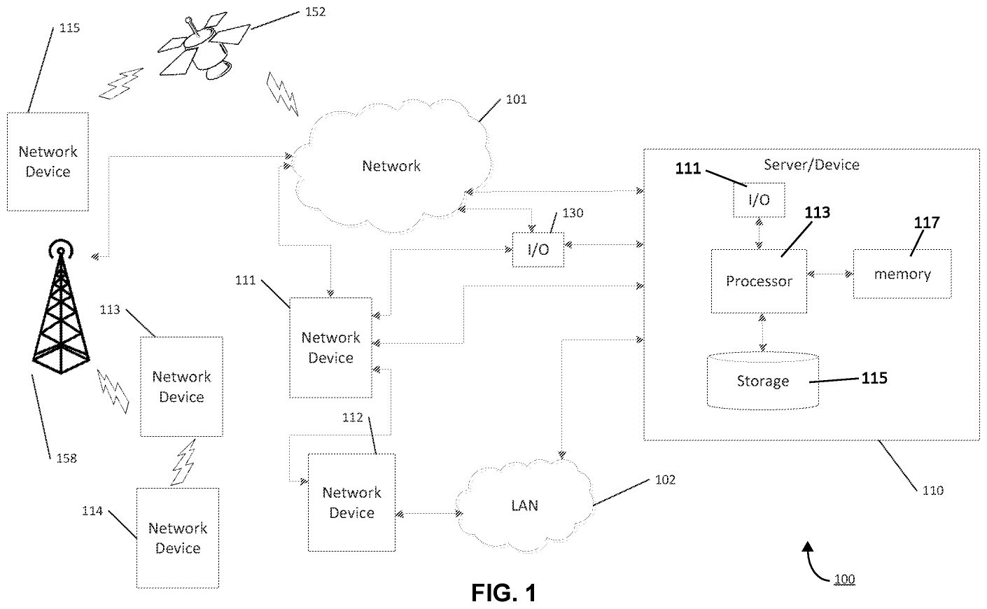

FIG. 1 illustrates an exemplary block diagram of a communication system for control of one or more network devices according to an embodiment.

Referring to FIG. 1, communication network 100 which is configured to communicate and/or control display signs 110-115 described herein, e.g., network devices, network signs, and/or network displays. In one embodiment, the display or sign includes a heating source controlled by a controller and one or more sensors described herein. The thermostat of the display or sign can be controlled over the system 100. The system can also monitor the one or more sensors including, e.g., [add details].

In this embodiment, each display or sign 110 further includes one or more of an input/output (I/O) unit 111, a processor 113, a storage 115, and a memory 117 in electrical communication with a thermostat, a heat source, a controller and one or more sensors of the sign. The display or sign is configured for remote operation and/or monitoring and the thermostat and one or more sensors as described in embodiments herein are each configured for remote operation and/or monitoring with the system 100. Moreover, the heat source as described in embodiments herein can be controlled remotely or programmed to operate within a predetermined temperature range.

The system includes a network 100 includes one or more networks, including wide-area network 101, e.g., the Internet, company or organization Intranet, and/or sections of the Internet (e.g., virtual private networks, Clouds, and the Dark Web), and local-area network 102, e.g., interconnected computers localized at a geographical and/or organization location and ad-hoc networks connected using various wired means, e.g., Ethernet, coaxial, fiber optic, and other wired connections, and wireless means, e.g., Wi-Fi, Bluetooth, and other wireless connections.

Communication network 100 includes a number of network devices, e.g., signs, 110-115 that are in communication with the other devices through the various networks 101 and 102 and through other means, e.g., direct connection through an input/output port of a network device 130, direct connection through a wired or wireless means, and indirect connection through an input-output box, e.g., a switch.

Network devices, e.g., signs 110-115, may also connect through the networks 101 and 102 using various routers, access points, and other means. For example, network sign 113 wirelessly connects to a base station 158, which acts as an access point to the wide area network 101. Base station 158 may be a cellular phone tower, a Wi-Fi router or access point, or other devices that allow a network device, e.g., wireless network device 113, to connect to a network, e.g., wide area network 101, through the base station 158. Base station 158 may be connected directly to network 101 through a wired or wireless connection or may be routed through additional intermediate service providers or exchanges. Wireless device 113 connecting through base station 158 may also act as a mobile access point in an ad-hoc or other wireless network, providing access for network device 115 through network sign 113 and base station 158 to network 101.

In one embodiment, there may be multiple base stations, each connected to the network 101, within the range of network device 113. In addition, a network device, e.g., network sign 113, may be travelling and moving in and out of the range of each of the multiple base stations. In such case, the base stations may perform handoff procedures with the network device and other base stations to ensure minimal interruption to the network device's connection to network 101 when the network sign is moved out of the range of the handling base station. In performing the handoff procedure, the network sign and/or the multiple base stations may continuously measure the signal strength of the network sign with respect to each base station and handing off the network sign to another base station with a high signal strength to the network sign when the signal strength of the handling base station is below a certain threshold. The network sign may be a portable sign that is configured to move to various locations.

In another embodiment, a sign, e.g., network sign 115, may wirelessly connect with an orbital satellite 152 directly, indirectly or in combination, e.g., when the network device is outside of the range of terrestrial base stations or other for other reasons. The orbital satellite 152 may be wirelessly connected to a terrestrial base station that provides access to network 101 as known in the art.

In yet another embodiment, the orbital satellite 152 or other satellites may provide other functions such as global positioning and providing the network sign with location information or estimations of location information of the network sign directly without needing to pass information to the network 101. The location information or estimation of location information is known in the art. The network sign may also utilize use geolocation methods, e.g., global position system (GPS) techniques to determine location as known in the art, measuring and analyzing signal strength, using the multiple base stations to determine location without needing to pass information to the network 101. In an embodiment, the global positioning functionality of the orbital satellite 152 may use a separate interface than the communication functionality of the orbital satellite 152 (e.g., the global position functionality uses a separate interface, hardware, software, or other components of the network device 113 than the communication functionality) and the like. In another embodiment, the orbital satellite with the global position functionality is a physically separate satellite from the orbital satellite with communication functionality

In yet another embodiment, a sign, e.g., network sign 112, may connect to wide area network 101 through the local area network 102 and another network device, e.g., network sign 110. Here, the network sign 110 may be a server, router, gateway, or other devices that provide access to wide area network 101 for devices connected with local area network 102. The network sign may include features described in any embodiments herein. Optionally and/or alternatively, the network sign may include a I/O 140 electrically connected to a processor 142 electrically connected to storage 144 electrically connected to memory 146. The communication system 100 may also be in connection with server or distributed computer network for processing, controlling and/or configuring the network devices, e.g., signs, described herein.

In one embodiment, the communication system 100 is configured to communicate with a plurality of units 110-115, a wireless communication system 100 configured to transfer information between the plurality of units 110-115, and a control device configured to transmit information to at least one unit of the plurality of units 110-115. In many embodiments, each unit of the plurality of units 110-115 comprises a display or a plurality displays, a controller of a plurality of controllers, a transceiver of a plurality of transceivers and a heating system as described in embodiments herein.

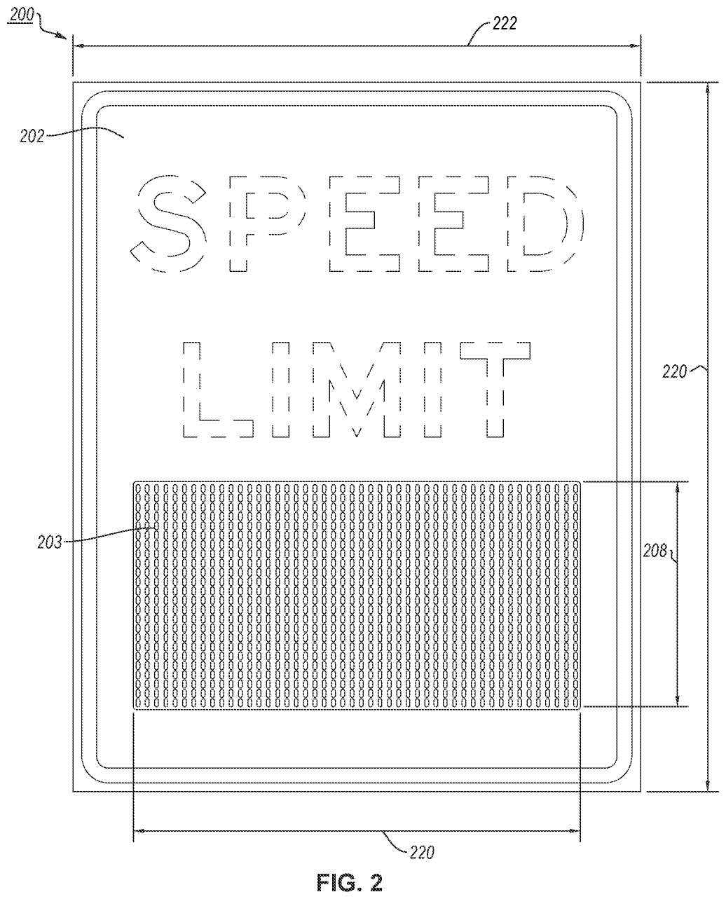

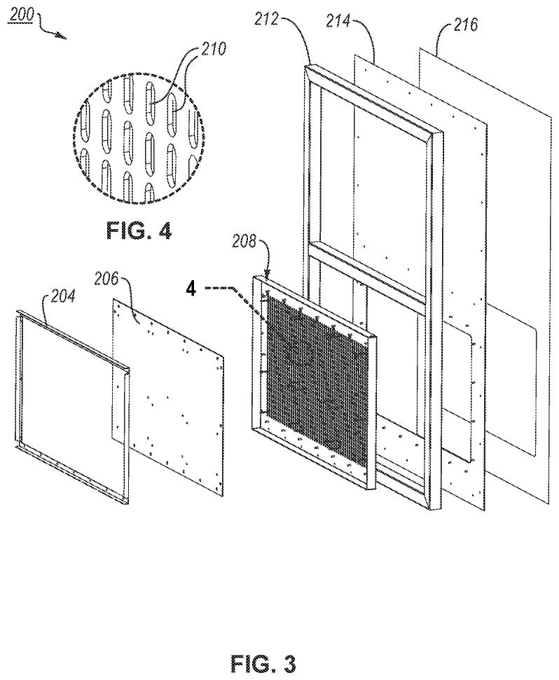

FIG. 2 illustrates an exemplary perspective front view of a sign with a heating unit according to an embodiment of the invention. FIG. 3 illustrates an exemplary exploded view of the sign of FIG. 2. FIG. 4 illustrates a magnified view of an aperture of the sign shown in FIG. 2.

Referring now to FIGS. 2-4, the network device 200, e.g., sign, includes a front surface 202, a bracket 204, a glazing 206, adjacent the one or more circuit boards (not shown) and electronics for sign operation. The glazing 206 includes a transparent or optically transparent material and configured to prevent moisture and external elements from contacting or interfering with the light source, e.g., light-emitting diodes (LEDs) or others configured to illuminate the sign. In one embodiment, the glazing 206 can include a material plastic material, thermoplastic material, a polymer material, polycarbonate material, acrylic material, and combinations of the same. In a preferred embodiment, the glazing 206 is optically clear or substantially optically clear. The bracket 204 is used to couple or attach the glazing 206 to mask 208. The mask 208 includes a plurality of apertures 210 (FIG. 4) and a heating source 700 attached to an inside surface of the glazing. The apertures are sized to allow light to be transmitted from a lighting source, e.g., LEDs.

The sign 200 also includes a bracket 212, a first panel 214, and a surface portion 216 having a surface 202. The heat source (as described in embodiments herein) is attached or adjacent to the glazing the heat source is controlled with a controller as described herein. Optionally and/or alternatively, the heat source is controlled over the communication system 100 described herein.

In this embodiment, the display sign apparatus 200 includes a front surface 202 with one or more graphics, e.g., lettering, numbering, shapes, pictures, colors, symbols and/or on the front surface 202 and an active display region 203. The active display region 203 includes one or more illumination sources, e.g., light-emitting diodes (LEDs) or other illumination sources, in electrical communication with an electronic board, e.g., printed circuit board or the like. The active display region 203 includes a height 218 and a width 220. The height 218 can be in a range from about 1 ft to about 2 ft or taller. The width 220 can be in a range from about 1 ft to about 3 ft or wider. For other signs or displays the active display region in height 218 can be in a range from about 1 ft to about 30 ft or greater and a width 220 can be in a range from about 2 ft to about 100 ft or greater.

The sign 200 also includes a height 220 and a width 222. The height can be in a range from about 4 ft to about 10 ft greater or less. The width 222 can be in a range from about 3 ft to about 4 ft greater or less. The sign can be opened and closed to have access to the internal components of the sign. For other signs or displays the active display region in height can be in a range from about 1 ft to about 30 ft or greater and a width can be in a range from about 2 ft to about 100 ft or greater. Optionally and/or alternatively, the sign 200 can be more than one sign pieced together to create a larger sign. For example, the sign can have any number of active regions.

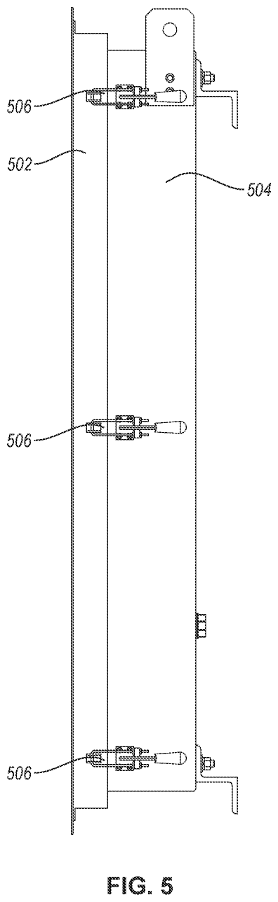

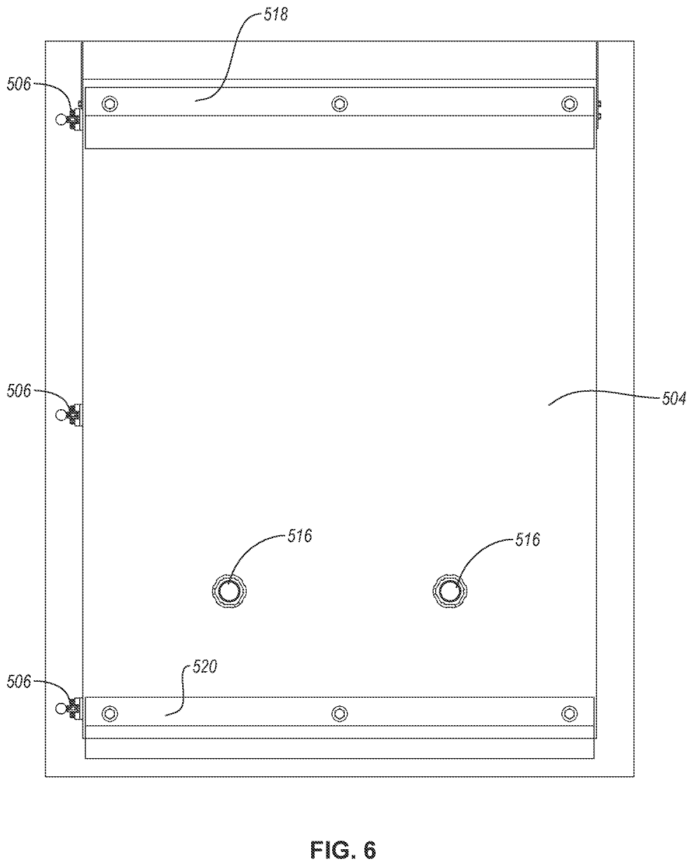

FIG. 5 illustrates an exemplary rear view of the sign of FIG. 2. FIG. 6 illustrates an exemplary rear view of the sign of FIG. 2.

Referring to FIGS. 5-6, the sign 200 includes a housing having a

The sign 200 is housed in housing including a first housing 502 releasably attached to a second housing 504. The housing is configured to be weatherproof and optionally waterproof. The first housing 502 is attachment to the second housing 502 with one or more mechanisms 506, e.g., claps, snaps, or other attachment mechanism configured to couple the first housing 502 to the second housing 504. Optionally, and/or alternatively, the housing can also be insulted in one embodiment to protect the internal components from the cold. The second housing 504 includes a rear surface. In one embodiment the first housing 402 is attached to the second housing with a hinge mechanism 412 and in an open configuration is supported with a brace 414. The second housing 404 includes one or more access points or lumens 516 to provide access to an interior of the housing. Also, the housing 504 can include a one or more mounting brackets, e.g., a first bracket 518 and a second bracket 520 configured to mount the sign to a predetermined location or structure (not shown). the housing. The housing also includes mounting brackets or other attachment mechanisms to attach the housing to any desired location.

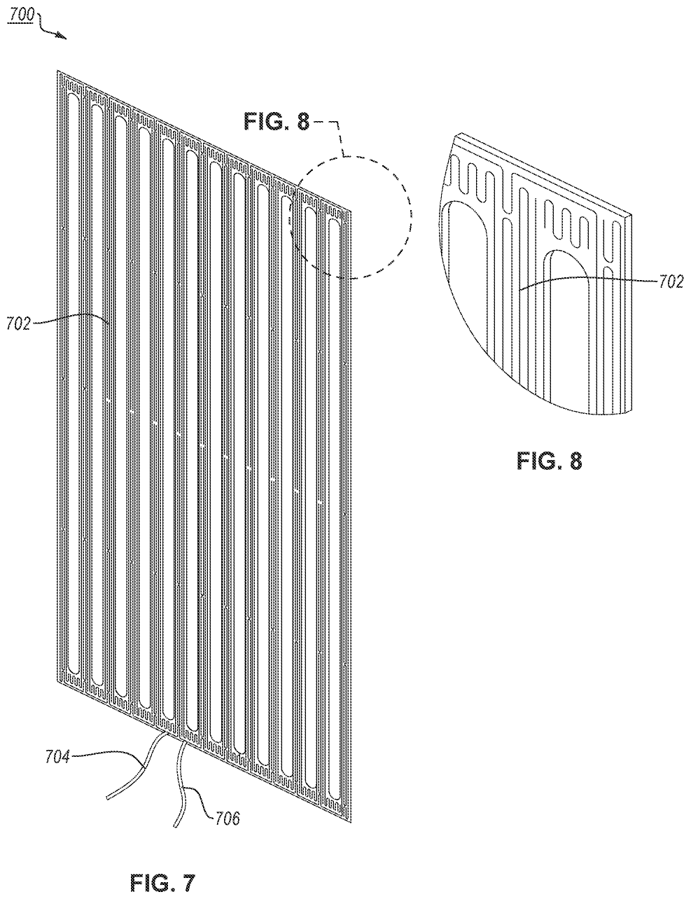

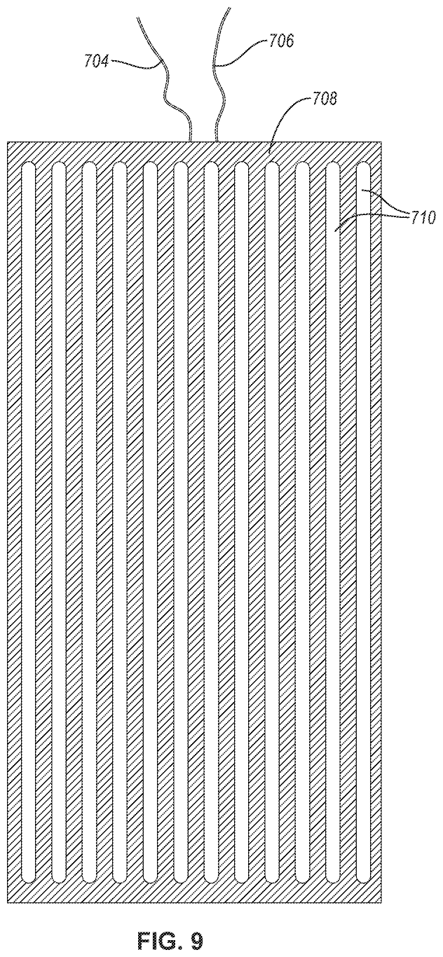

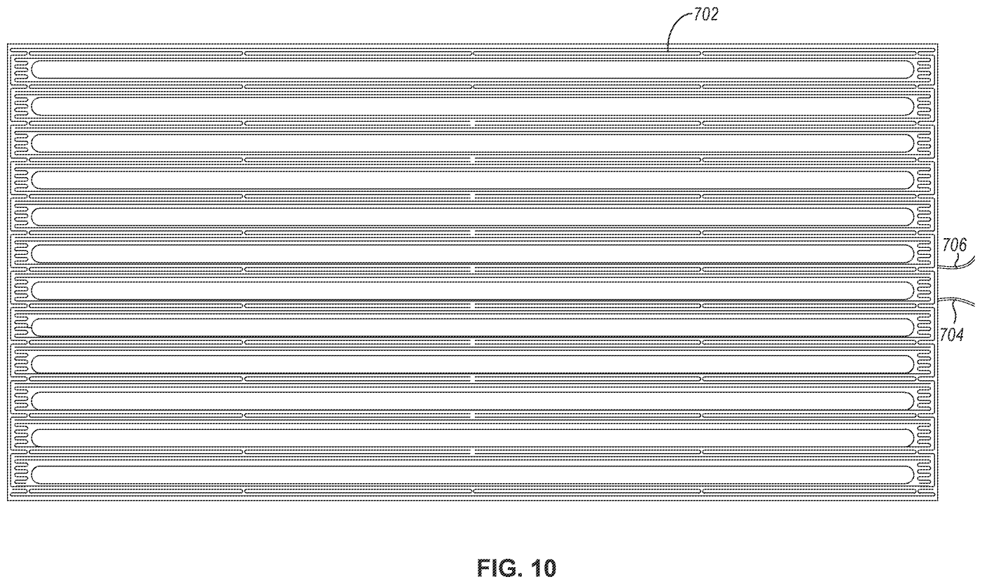

FIG. 7 illustrates an exemplary perspective view of a heating unit according to an embodiment. FIG. 8 illustrates an exemplary magnified view of the heating unit of FIG. 7. FIG. 9 illustrates an exemplary rear view of the heating unit of FIG. 7. FIG. 10 illustrates an exemplary front view of the heating unit of FIG. 7.

Referring to FIGS. 7-10, a heating source is generally depicted with reference to number 700. The heating source 700 includes a plurality of embedded heating wires 702 coupled to an input 704 and output 706. The embedded material, e.g., heating wires or patterned material, are configured as a material that increases in temperature as current or electricity is applied via the input 704 and/or output 706. The input and/or output are in electrical communication with a power source through a temperature regulator such as a thermostat as known in the art. The temperature regulator can be remotely controlled over the network described herein. The material is embedded, encapsulated, or covered with another material, e.g., Kapton, silicon, fiberglass, plastic, polymer, thermoplastic, combinations of the same and the like. The heating source 700 is configured to be attached or adhered directly to a portion of sign. In a preferred embodiment, the heating source is configured in a pattern to surround or partially surround one or more apertures, e.g., apertures 210, as described herein. Alternatively, the heat source can be integral with any component of the sign for example the heat source can internal component of the mask 208, e.g., arranged or sandwiched between such integral component, e.g., mask, glazing, face of the sign combinations of the same and the like.

In one embodiment, the heating material 702 can be any thickness and geographic pattern. In one embodiment, the heat material 702 are in electrical communication with a thermostat (not shown) and controller. The heating material 702 can be a coated or non-coated heat material. The coating will protect the heat source from external conditions, e.g., environmental conditions. The coating can be made from a material including, e.g., Kapton, silicon, fiberglass, plastic, polymer, thermoplastic, combinations of the same and the like. In a preferred embodiment, the heat material is an etched foil heat material in a predetermined pattern. The etch foil is activated to increase temperature with a power density in a range from about 2 w/cm² to about 5 w/cm² or greater.

In this embodiment, the heating material 702 are constructed from electrically conductive materials such as metal, alloy, plastic conductive materials, polymer conductive materials, foils combination of the same and the like, e.g., copper or aluminum materials. Optionally and/or alternatively, the heating source can include a heated fluid and/or heated air flow. The heated fluid and/or air can be in a tubing. The heating material and can heat to a temperature in range from about 32° F. to about 100° F. or higher. In a preferred embodiment, the heating material is embedded in a protective material, e.g., Kapton, silicon, fiberglass, thermal plastic, combinations of the same and the like or other materials described herein. The rear surface the heat source 700 includes an adhesive material 708 configured to be attached to a predetermined location, e.g., aperture. In this embodiment, each aperture is at least partially surrounded with patterned heating material. The heat source 700 also includes a plurality of openings 710 sized to at least partially surround an opening of one or more apertures.

Optionally and alternatively, the heating material can have any pattern and number of holes of the aperture, e.g., configured to correspond to the apertures of the mask or other desired location.

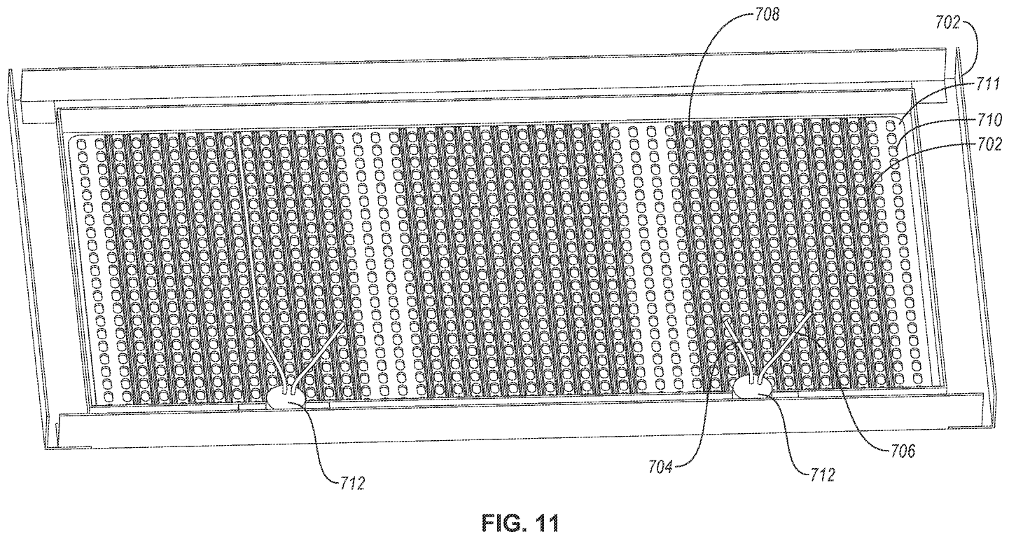

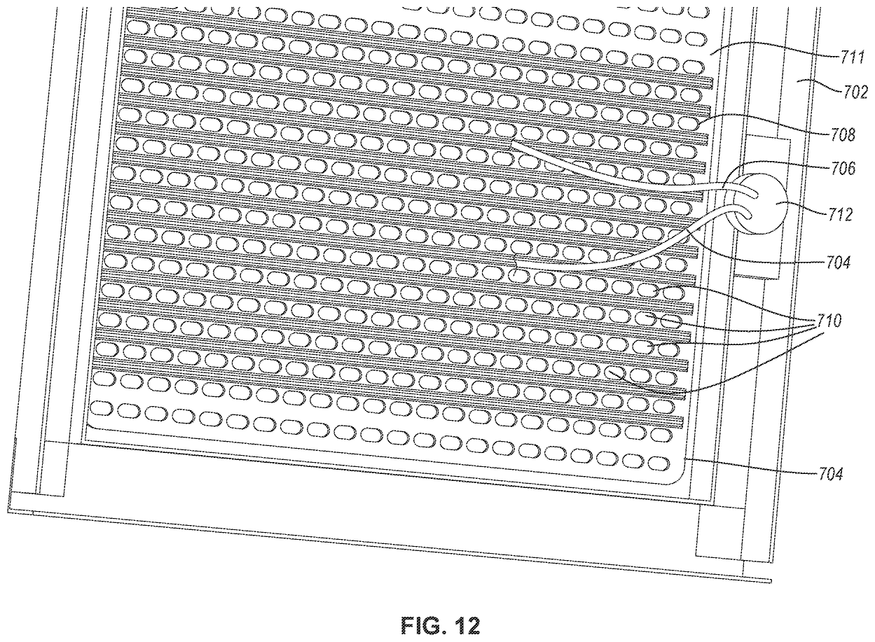

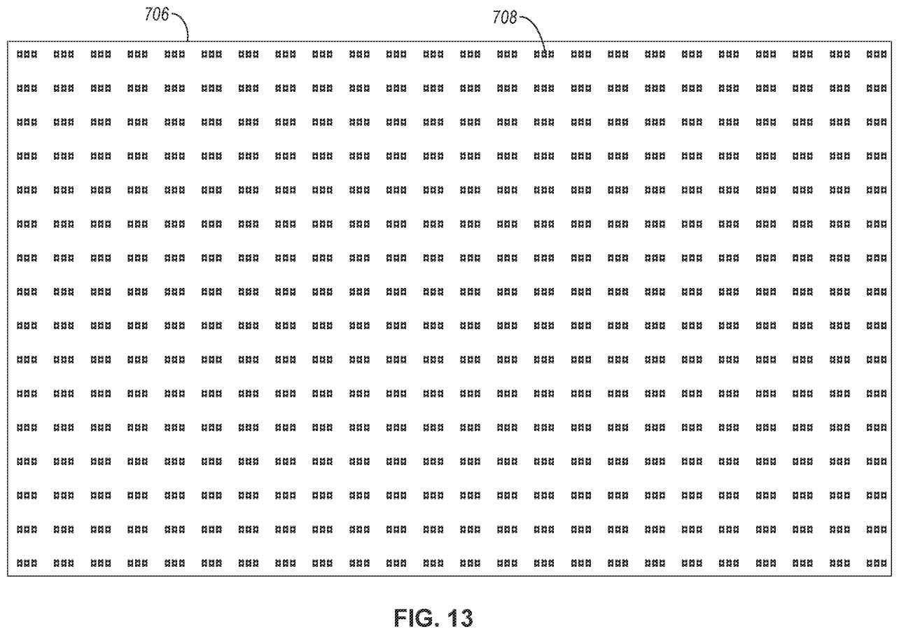

FIG. 11 illustrates an exemplary view of an interior of a sign according to an embodiment of the invention. FIG. 12 illustrates an exemplary magnified view of the sign FIG. 11. FIG. 13 illustrates an exemplary LED panel of the sign in FIG. 11.

Referring to FIGS. 11-13, the sign 700 includes a front surface, a bracket 702, a glazing 705, adjacent the one or more circuit boards 706. Each circuit board includes three LEDs 708 per aperture. The glazing 705 is transparent or optically transparent and configured to prevent moisture and external elements from contacting or interfering with the plurality of light-emitting diodes (LEDs) units 708 of the circuit board 706. LED units 708 include each include a red LED, a green LED and a blue LED. Optionally and/or alternatively, the LED unit can be an integrated unit with one LED that is configured to emit red, green and blue.

The glazing 705 can include a material plastic material, thermoplastic material, polycarbonate material, acrylic material, and combinations of the same. In a preferred embodiment, the material is optically clear or substantially optically clear. The bracket 702 is used to couple or attach the glazing 705 to mask 711. The mask 711 includes a plurality of apertures 708 at least partially surrounded with a heating source 700 and heating material attached to an inside surface of the glazing 705. The heating source 700 can be attached mechanically, with adhesive or combination. In this embodiment, a surface of the heating source 700 includes an adhesive 708. The heat source 700 is attached to the glazing 705 or directly to the mask 711 is controlled with a controller as described herein. In this embodiment, there are three different heat sources 700, three separate thermostats 712 one for each heat source 700. The controller and/or thermostat can be controlled over the communication system 100.

Optionally and/or alternatively, one or more sensors may be used with or without the thermostat to control the operation of the heat source. The sensors can include one or more of: ice sensors configured to determine if ice is present, snow sensor configured to determine if it is snowing, a moisture sensor configured to determine if a predetermined amount of moisture is on the display, a barometric sensor, an optical sensor configured to determine is snow, ice or moisture is obstructing the display, a temperature sensor, and other sensors indicative of snow or ice and combinations of the same. For example, the sensors can monitor temperature, weather, snow, ice or other predetermined condition and activate or deactivate the heat source.

Particular example implementations of the subject matter have been described. As will be apparent to those skilled in the art, other implementations, alterations, and permutations of the particular implementations are considered to be within the scope of the disclosure and the following claims. Features of the various implementations are also combinable. While operations are depicted in the drawings or claims in a particular order, this should not be understood as requiring that such operations be performed in the particular order shown or in sequential order, or that all illustrated operations be performed (some operations may be considered optional), to achieve desirable results.

While this disclosure contains many specific implementation details, these should not be construed as limitations on the scope of any invention or on the scope of what may be claimed, but rather as descriptions of features that may be specific to particular implementations of particular inventions. Certain features that are described in the context of separate implementations can also be implemented, in combination, in a single implementation.

Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Accordingly, the previously described example implementations do not necessarily define or constrain this disclosure. Other changes, substitutions, and alterations are also possible within the scope of this disclosure.

To avoid unnecessarily obscuring the present disclosure, the preceding description may omit a number of known structures and devices. This omission is not to be construed as a limitation of the scopes of the claims. Specific details are set forth to provide an understanding of the present disclosure. It should however be appreciated that the present disclosure may be practiced in a variety of ways beyond the specific detail set forth herein.

Also, while the flowcharts have been discussed and illustrated in relation to a particular sequence of events, it should be appreciated that changes, additions, and omissions to this sequence can occur without materially affecting the operation of the disclosed embodiments, configuration, and aspects. A number of variations and modifications of the disclosure can be used. It would be possible to provide for some features of the disclosure without providing others.

Moreover, though the description has included a description of one or more aspects, implementations, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges, or steps to those claimed, whether or not such alternate, interchangeable and/or equivalent structures, functions, ranges or steps are disclosed herein, and without intending to publicly dedicate any patentable subject matter.

1. A sign configured to prevent or minimize snow and icing from blocking a display portion of the sign, comprising:
a housing;
one or more circuit boards comprising a plurality of light emitting diodes (LEDs);
a mask attached to the housing and adjacent to the one or more circuit boards, the mask having a plurality of apertures aligned with plurality of light emitting diodes (LEDs);
a heat source attached to the mask and surrounding a plurality of the plurality of apertures; and
a thermostat attached to the mask and the thermostat is configured to control the heat source based on a predetermined temperature range.

2. The sign of claim 1, further comprising a glazing adjacent the one or more circuit boards.

3. The sign of claim 1, further comprising a surface portion attached to the housing including a letter, a number, shape, graphic and/or symbol.

4. The sign of claim 1, wherein the heat source comprises an etched foil material configured to be heated with electrical energy.

5. The sign of claim 4, wherein the etched foil material comprises a conductive material.

6. The sign of claim 4, wherein the etched foil material comprises a protective coating.

7. The sign of claim 6, wherein the protective coating comprises a thermoplastic material.

8. The sign of claim 1, wherein the heat source comprises a heat source material configured to be heated with electrical energy and the heat source material is at least partially surrounded with a protective coating comprising one or more of a Kapton material, a silicon material, a polyimide material, a rubber material, combinations of the same and the like.

9. The sign of claim 4, wherein the etched foil material is configured to have a heat flux of about 15 watts/in² or less.

10. The sign of claim 1, wherein the heat source comprises a coated etched foil material having a thickness in a range from about 0.010 inch or greater.

11. The sign of claim 1, wherein the heat source comprises a an etched foil material with a protective coating at least partially surrounding the etched foil material and at least a portion of the etched foil material is configured to reach a temperature of about 450° F. or less.

12. The sign of claim 5, wherein the etched foil material is formed in geometric pattern surrounding one of the plurality of apertures.

13. An apparatus configured to prevent or minimize snow and ice from blocking a display portion of the apparatus, the apparatus comprising:
a housing;
one or more circuit boards comprising a plurality of light emitting diodes (LEDs);
a glazing adjacent the one or more circuit boards;
a mask attached to the housing and adjacent to the glazing, the mask having a plurality of apertures aligned with plurality of light emitting diodes (LEDs);
a surface portion attached to the housing including a letter, a number, shape, graphic and/or symbol on a front surface portion;
a heat source comprising a protective coated heat source material at least partially surrounding one or more of the plurality of apertures; and
a controller configured to control the heat source based on predetermined condition.

14. The apparatus of claim 13, wherein the controller comprises a thermostat configured to control the heat source and the predetermined condition comprises a predetermined temperature range.

15. The apparatus of claim 13, wherein the controller comprises one or more of a senor and a thermostat.

16. The apparatus of claim 13, wherein the controller is in electrical communication with one more sensor comprising at least an optical sensor configured to estimate whether or not the apparatus is obstructed with snow or ice.

17. The apparatus of claim 13, wherein the predetermined condition comprises one or more of a time of day, a time of year, a schedule of snowplows, a time of heater operation, weather conditions, combinations of the same and the like.

18. The apparatus of claim 13, wherein the protective coated heat source material comprises an etched foil material.

19.-30. (canceled)

31. An apparatus configured to prevent or minimize snow and ice from blocking a display portion of the apparatus, the apparatus comprising:
a housing;
one or more circuit boards comprising a plurality of light emitting diodes (LEDs);
a glazing adjacent the one or more circuit boards;
a mask attached to the housing and adjacent to the glazing, the mask having a plurality of apertures aligned with plurality of light emitting diodes (LEDs);
a surface portion attached to the housing including a letter, a number, shape, graphic and/or symbol on a front surface portion;
a heat source attached to the mask and surrounding a plurality of the plurality of apertures; and
a controller configured to control the heat source based on predetermined condition, wherein the controller is configured to be controlled remotely over a network.

32. The apparatus of claim 31, wherein the network comprises one or more of a wireless network, a cellular network, a Wi-Fi network, a 5G network, and combinations of the same.

33. The apparatus of claim 31, wherein the heat source comprises a heat source material at least partially surrounded with a protective material and the heat source material is configured to be heated with application of an electrical current.
